(19) United States
(12) Patent Application Publication
(10) Pub. No.: US 2022/0220021 A1
(43) Pub. Date: Jul. 14, 2022

(54) GLASS ARTICLES, METHODS FOR THE PRODUCTION THEREOF AND USES

(71) Applicant: Schott AG, Mainz (DE)

(72) Inventors: Holger Wegener, Alfeld (DE); Simon Striepe, Rosdorf (DE); Olaf Claussen, Undenheim (DE); Marta Krzyzak, Bad Gandersheim (DE); Michael Hahn, Hohenstein (DE); Karin Naumann, Ober-Olm (DE); Silke Knoche, Saulheim (DE); Jörg Witte, Pfungstadt (DE)

(73) Assignee: Schott Ag, Mainz (DE)

(21) Appl. No.: 17/708,219

(22) Filed: Mar. 30, 2022

Related U.S. Application Data
(63) Continuation of application No. PCT/EP2020/076928, filed on Sep. 25, 2020.

(30) Foreign Application Priority Data
Sep. 30, 2019 (DE) 10 2019 126 332.8

(51) Int. Cl. C03C 3/091; C03C 1/00; C03C 3/085

(52) U.S. Cl. CPC C03C 3/091; C03C 3/085; C03C 1/004

(57) ABSTRACT

A glass article is composed of an aluminosilicate glass with at least one halogen with refining action in an amount ranging from 500 ppm to 8000 ppm and an Sn content of less than 500 ppm. The glass has less than 100 ppm As and less than 100 ppm Sb and the glass article has a thickness of less than 250 μm.

### CROSS REFERENCE TO RELATED APPLICATIONS

This is a continuation of International Patent Application No. PCT/EP2020/076928 entitled “GLASS ARTICLES, METHODS FOR THE PRODUCTION AND USES THEREOF,” filed on Sep. 25, 2020, which is incorporated in its entirety herein by reference. International Patent Application No. PCT/EP2020/076928 claims priority to German Patent Application No. DE 10 2019 126 332.8 filed on Sep. 30, 2019, which is incorporated in its entirety herein by reference.

### BACKGROUND OF THE INVENTION

### 1. Field of the Invention

The present invention relates to glass articles, methods for the production thereof and uses. The glass articles are suitable to serve as display glass, for example, for mobile telephones and tablet computers.

### 2. Description of the Related Art

Manufacturers of mobile end devices such as in particular smart phones and tablet computers must contend with increasing market saturation. It is difficult to get consumers to buy new devices as a result of interesting features. There is a dilemma, on one hand, to make available ever more brilliant and larger displays in order to depict multimedia content in as impressive a manner as possible on the portable screens and, on the other hand, to keep the size of the devices on an acceptable scale. Work is being done in particular on foldable and bendable displays. Smart phones with curved screens are already successful in the market. In order to be able to satisfy the wishes of customers, there is high demand for innovative materials for such displays.

Glass is the material of choice for displays as a result of its chemical resistance, durability and transparency. So that glass can be curved, it must be made available in small thicknesses. There are already various methods for being able to produce glass with a very small thickness. Glass with very small thicknesses can be produced using drawing methods. These drawing methods include the down draw method (also referred to as the “slot down draw” method) and the overflow fusion method (also referred to as the “overflow down draw” method). These methods have in common that platinum components are used in the corresponding production facilities.

It has been found in the production of thin glass that platinum particles detach from noble metal components in the production facilities and are found again on or in the thin glass articles. In glass articles with a greater thickness, these platinum particles are, as a result of their small size, less critical than in particularly thin glass articles. A single platinum particle with a size of only 5 μm diameter in the case of a glass of 50 μm thickness can thus represent a very significant defect since the surfaces can bulge around the enclosed defect.

Aluminosilicate glass melts at comparatively high temperatures as a result of their high Al₂O₃ content. They are more difficult to refine than many other glasses since they only reach a normal refining viscosity (200 to 500 dPas) at very high temperatures. It has been shown to be particularly difficult to achieve a satisfactory refining action without the use of poisonous refining agents such as arsenic and antimony oxides. Many alternative refining agents release refining gas at excessively low temperatures. The viscosity of the glass is then still too high such that the bubbles formed do not rise quickly enough or not at all.

Alkali metal oxides reduce the melting and refining temperature of a glass so that the desired refining viscosity is already achieved at lower temperatures. Glasses which have a high amount of alkali metal oxides, however, exhibit a high degree of corrosion potential to tank blocks and noble metal components. It is exactly noble metal which is present in many components in glass production, e.g. in the form of tubes to transport the glass melt from the melt tank to the homogenisation and shaping system, which is attacked to a high degree. This leads to short service lives of the facilities and thus to high costs.

WO 2009/108285 A2 teaches complex refining agents for aluminosilicate glasses which are based on the use of multivalent metal oxides and water. Glasses with bubble concentrations of up to one bubble per cm³ glass are obtained there. Tin and cerium oxides are used as multivalent metal oxides.

Facilities for producing thin and flat glasses generally contain noble metal parts such as platinum tubes. WO 2006/115997 A2 thus describes facilities for producing glass which have noble metals, in particular platinum. The effect of “hydrogen permeation blistering” is described, i.e. a formation of bubbles on the inside of platinum parts as a result of the permeability of these material to hydrogen. The use of tin oxide is particularly recommended there since it is supposed to absorb bubbles which are still present during cooling of the melt. In order to amplify the “hydrogen permeation blistering”, iodine, bromine or chlorine should be used in very small quantities together with control of the hydrogen partial pressure outside the facility.

It would be desirable to provide aluminosilicate glasses in outstanding quality without having to use complex refining agent combinations or high outlay in terms of equipment. The glasses should also be free of arsenic and antimony and attack the material of the facility to as small a degree as possible.

### SUMMARY OF THE INVENTION

In some exemplary embodiments provided according to the present invention, a glass article is composed of an aluminosilicate glass with at least one halogen with refining action in an amount ranging from 500 ppm to 8000 ppm and an Sn content of less than 500 ppm. The glass has less than 100 ppm As and less than 100 ppm Sb and the glass article has a thickness of less than 250 μm.

In some exemplary embodiments provided according to the present invention, a glass article is composed of an aluminosilicate glass. The glass article has no more than 5 platinum particles with diameters of greater than 5 μm per kilogram of glass. The aluminosilicate glass has less than 100 ppm As and less than 100 ppm Sb and the glass article has a thickness of less than 250 μm.

In some exemplary embodiments provided according to the present invention, a glass article is composed of an aluminosilicate glass. The aluminosilicate glass has less than 100 ppm As, less than 100 ppm Sb and less than 500 ppm Sn and a quotient A lies in the range from 1.5 to 8.5, the glass article has a thickness of less than 250 μm and the following applies:

$$A = \frac{\frac{{m}_{Al 2 O 3}}{{m}_{RO} + {m}_{R 2 O}}}{{m}_{Cl} + {m}_{I} + {m}_{Br}} ,$$

where M_{Al2O3} is a mass amount of Al₂O₃ in the aluminosilicate glass in wt.-%; M_{R2O} is a sum of mass amounts of alkali metal oxides Na₂O, K₂O and Li₂O in wt.-%; m_{RO} is a sum of mass amounts of alkaline earth metal oxides MgO, CaO, BaO and SrO in weight percent; m_{Cl} is a mass amount of chlorine in wt.-%; m_{I} is a mass amount of iodine in wt.-%; and m_{Br} is a mass amount of bromine in wt.-%.

In some exemplary embodiments provided according to the present invention, a glass article is composed of an aluminosilicate glass. The aluminosilicate glass has less than 100 ppm As, less than 100 ppm Sb and less than 500 ppm Sn, a total thickness variation of the glass article is less than 5 μm, and the glass article has a thickness of less than 250 μm.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates the phase diagram of platinum and tin;

FIG. 2 is an SEM image of a sample of a noble metal tube which has been in contact with a glass melt which contains Sn over a longer period of time;

FIG. 3 is an SEM image of a sample of a noble metal tube which has been in contact with a glass melt which contains Sn over a longer period of time;

FIG. 4 is an SEM image of a sample of a noble metal tube which has been in contact with a glass melt which contains Sn over a longer period of time;

FIG. 5 is an SEM image of a sample of a noble metal tube which has been in contact with a glass melt which contains Sn over a longer period of time;

FIG. 6 is an SEM image of a sample of a noble metal tube which has been in contact with a glass melt which contains Sn over a longer period of time;

FIG. 7 shows one manifestation of platinum particles in glass which contains SnO₂; and

FIG. 8 shows one manifestation of platinum particles in glass which contains SnO₂.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

In some embodiments, the invention relates to a glass article composed of an aluminosilicate glass with at least one halogen with refining action in the range from 500 to 8000 ppm and an Sn content of less than 500 ppm, wherein the glass has less than 100 ppm As and less than 100 ppm Sb.

In some embodiments, the invention relates to a glass article composed of an aluminosilicate glass, wherein the glass article has no more than 5 platinum particles with diameters of greater than 5 μm per kilogram of glass, wherein the aluminosilicate glass has less than 100 ppm As and less than 100 ppm Sb.

In some embodiments, the invention relates to a glass article composed of an aluminosilicate glass, wherein the aluminosilicate glass has less than 100 ppm As, less than 100 ppm Sb and less than 500 ppm or less than 100 ppm Sn and wherein a quotient A lies in the range from 1.5 to 8.5, wherein the following applies:

$$A = \frac{\frac{{m}_{Al 2 O 3}}{{m}_{RO} + {m}_{R 2 O}}}{{m}_{Cl} + {m}_{I} + {m}_{Br}}$$

In the formula, M_{Al2O3} is the mass amount of Al₂O₃ in the aluminosilicate glass in wt.-%; M_{R2O} is the sum of the mass amounts of the alkali metal oxides Na₂O, K₂O and Li₂O in wt.-%; m_{RO} is the sum of the mass amounts of the alkaline earth metal oxides MgO, CaO, BaO and SrO in weight percent; mci is the mass amount of chlorine in wt.-%; m_{Cl} is the mass amount of iodine in wt.-%; and m_{Br} is the mass amount of bromine in wt.-%.

In some embodiments, the invention relates to a glass article composed of an aluminosilicate glass, wherein the aluminosilicate glass has less than 100 ppm As, less than 100 ppm Sb and less than 500 ppm, for example less than 100 ppm Sn, and a total thickness variation of the glass article is less than 5 μm.

The aluminosilicate glass has at least one halogen with refining action, in particular selected from chlorine, bromine and iodine. Fluorine is not a halogen with refining action since it is already volatile at excessively low temperatures. The glass can, however, contain fluorine. An exemplary halogen with refining action is chlorine. The halogen content with refining action can be at least 100 ppm, at least 300 ppm or at least 500 ppm. In some embodiments, the halogen content is at most 8000 ppm, at most 6500 ppm, at most 5000 ppm, at most 3000 ppm, at most 2500 ppm or at most 1000 ppm. Halogens with refining action serve as refining agents to remove bubbles during the production of the glass article. The halogen with refining action can be added in different forms. In some embodiments, it is added as salt with an alkali metal or alkaline earth metal cation to the mixture. In some embodiments, the halogen is used as salt and the cation in the salt corresponds to a cation which is present as an oxide in the aluminosilicate glass.

It is surprising that very good qualities can be obtained when using halogens as refining agents for aluminosilicate glass. As a result of their relatively low boiling point, halogens release refining gas already comparatively early in the melting process. Moreover, in contrast to multivalent metal oxides, halogens with refining action cannot absorb any oxygen during cooling of the melt. It was therefore the conventional wisdom that halogens had in any event to be used in combination with other refining agents, in particular with multivalent metal oxides, above all, SnO₂, in order to achieve a satisfactory result. The inventors of the present invention have ascertained that very good refining results can be achieved even without using tin, arsenic or antimony oxides. The aluminosilicate glass may be free from such refining agents.

In some embodiments, one or more additional refining agents can be used in addition to the halogen with refining action. This applies in particular to cerium and/or ferrous oxide. In some embodiments, the glass therefore contains CeO₂ and/or Fe₂O₃. CeO₂ can be contained, for example, in an amount range of up to 2000 ppm or up to 1000 ppm. This quantity alone is not sufficient for the refining. Together with the halogen with refining action, however, a very good result can be achieved. The amount of CeO₂ can be at least 100 ppm. Fe₂O₃ can be used, for example, in an amount range of up to 300 ppm. This quantity alone is not sufficient for the refining. Together with the halogen with refining action, however, a very good result can be achieved. The amount of Fe₂O₃ can be at least 100 ppm.

The aluminosilicate glass of the glass article can have an Sn content of less than 500 ppm, in particular less than 300 ppm, less than 100 ppm, less than 50 ppm or less than 10 ppm. In some embodiments, the glass has less than 100 ppm arsenic, in particular less than 50 ppm or less than 10 ppm. A glass which has less than 100 ppm antimony, less than 50 ppm antimony or less than 10 ppm antimony is exemplary. Arsenic and antimony are poisonous and damaging to the environment. They should therefore be avoided as a component of the glass article and are in any event no longer desired or not permitted in many applications. Great efforts have been made in the past to replace the refining agents arsenic and antimony, which are outstanding in terms of their refining action. Success has been achieved above all through the use of tin oxides as refining agents. When producing relatively thick glass articles, the use of tin oxide as a refining agent is largely unproblematic. It was thus nevertheless discovered that, when using tin oxide, platinum particles are released from platinum components, in particular if the glass flows through platinum tubes. These platinum particles are found again on and in the glass article. Very small platinum particles become apparent precisely in the case of thin glass articles since the solid particles are not reshaped during the shaping process and thus a thickened area arises which is significantly larger than the particle itself. Exemplary embodiments provided according to the present invention have succeeded in significantly reducing the quantity of platinum particles on and in the glass article. In some embodiments, the glass article has no more than 5 platinum particles with diameters of more than 5 μm, in particular more than 10 μm, per kilogram of glass. This relates in particular to particles with diameters of 5 to 100 μm. In some embodiments, the glass article has no more than 3, no more than 1 or no such platinum particles per kilogram of glass. Even one platinum particle with a diameter of more than 5 μm can lead to significant faults in the production of thin glass articles. The diameter of the platinum particles of this size can be determined microscopically, wherein the number indicated here in micrometres corresponds to the respective largest diameter of the particles. The glass article may have fewer than 10 of the stated platinum particles per square metre of glass article, in particular fewer than 8, fewer than 6, fewer than 4, fewer than 3, fewer than 2, fewer than 1 or even fewer than 0.5.

It was found that it can be advantageous if a quotient A lies in the range from 1.5 to 8.5, wherein the following applies:

$$A = \frac{\frac{{m}_{Al 2 O 3}}{{m}_{RO} + {m}_{R 2 O}}}{{m}_{Cl} + {m}_{I} + {m}_{Br}} .$$

In the formula, M_{Al2O3} is the mass amount of Al₂O₃ in the aluminosilicate glass in wt.-%; M_{R2O} is the sum of the mass amounts of alkali metal oxides Na₂O, K₂O and Li₂O in wt.-%; M_{RO} is the sum of the mass amounts of alkaline earth metal oxides MgO, CaO, BaO and SrO in weight percent; m_{Cl} is the mass amount of chlorine in wt.-%; m_{I} is the mass amount of iodine in wt.-%; and m_{Br} is the mass amount of bromine in wt.-%. Quotient A may be at least 1.5 or at least 2.0, such as at least 2.5. Quotient A may be at most 8.5, at most 7 or at most 5.

The glass articles provided according to the present invention have very low bubble concentrations. In particular, the number of bubbles with a length of more than 20 μm in the glass article is lower than 100 per kilogram of glass, in particular lower than 50 bubbles per kilogram of glass, lower than 20 bubbles per kilogram of glass or lower than 10 bubbles per kilogram of glass. The length of a bubble is its longest diameter.

In some embodiments, the glass article has a thickness of less than 500 μm, less than 350 μm, less than 250 μm, less than 200 μm or less than 100 μm. The thickness of the glass article may be at least 5 μm, at least 10 μm or at least 15 μm. In principle, the relationship found here naturally also works in the case of thicker glass so that, in some embodiments, the glass article has a thickness of 0.1 to 2 mm, in particular of 0.2 to 1 mm.

The glass article may be a thin glass panel, a glass wafer or a glass band. The glass article may be a flat glass body with two substantially plane-parallel sides which are significantly larger in terms of their surface areas than all the other sides. The glass article can be present in the form of a glass band which can be wound onto a roll. The glass article can be rectangular or round or have any other form. A rolled-up glass band can have a length of 10 to 1000 m.

The glass article can be produced using a drawing method, in particular using the down draw, overflow fusion or redrawing method. Outstanding surface quality which is characterised by a particularly low degree of roughness can be produced with these drawing methods. Such surfaces are also referred to as “fire-polished”. In some embodiments, the glass article has at least one fire-polished surface, in particular at least the two largest sides of the article are fire-polished. In particular, the article has a surface quality with a roughness Rₐ of at most 10 nm, at most 1 nm or at most 0.5 nm. Roughness Rₐ is determined with an Atomic Force Microscope (AFM).

As a result of the good quality in terms of platinum particles and bubbles, the glass article may be particularly uniform in terms of the thickness of the article. In particular, the article can have a total thickness variation (TTV) of less than 5 μm, in particular less than 3 μm, less than 2 μm or even less than 1 μm. The total thickness variation is the difference between the largest thickness and the smallest thickness of the glass article, it can be determined according to SEMI 1530 GBIR. The total thickness variation can apply to a surface of the glass article of at least 50 cm², at least 100 cm², at least 250 cm², at least 800 cm² or at least 1500 cm². The indicated total thickness variation can relate to a surface area of up to 10,000 cm² or up to 5000 cm². In some embodiments, the indicated TTV applies to the entire glass article. A thin glass article with a large number of platinum particles will not achieve this total thickness variation since the particles in the glass lead to bulges, i.e. to sections with increased thickness.

The glass article can have a surface area of at least 10 cm², at least 50 cm², at least 100 cm², at least 200 cm² or at least 400 cm². In some embodiments, the glass article can have a surface area of up to 25 m², up to 15 m², up to 100,000 cm², up to 60,000 cm², up to 10,000 cm² or up to 2000 cm². The surface area of the glass article is its length multiplied by its width.

In some embodiments, the aluminosilicate glass has less than 100 ppm fluorine or is free from fluorine. Fluorine can evaporate during production and as a result a non-homogenous glass can be produced. In some embodiments, the aluminosilicate glass nevertheless has fluorine since it serves as a flux agent during melting. In some embodiments, the glass contains fluorine in an amount of at least 0.05 wt.-%. In order to avoid the stated disadvantages, its content can nevertheless be restricted to at most 0.5 wt.-%.

The aluminosilicate glass can contain alkali metal oxide. In particular, the aluminosilicate glass can have lithium oxide, sodium oxide and/or potassium oxide (alkali metal oxides) in a total amount of more than 0.5 wt.-% or more than 2 wt.-% or more than 5 wt.-% or more than 10 wt.-%. In some embodiments, the aluminosilicate glass has less than 100 ppm lithium or is free from lithium. Lithium impairs the chemical resistance of the glass article and can attack crucible materials.

In some embodiments, the ratio of refining temperature T_{L} in ° C., at which the aluminosilicate glass has its refining viscosity, and temperature T_{B(Halogen)} in ° C. at the boiling point of the halogen compound used for the refining, for example, NaCl, is at most 1.2 or at most 1.15. Ratio T_{L}/T_{B(Halogen)} may be greater than 1.00 or greater than 1.05. It was found that good refining results are achieved when this ratio is adhered to. This is surprising since it was the accepted opinion that the refining temperature and boiling temperature of the refining agent should be approximately the same. Halogens were therefore not trusted to have a good refining action. In the context of this description, the refining temperature is the temperature at which the glass has a viscosity of 300 dPas. This does not mean that the glass was refined at this temperature. On the contrary, the temperature which corresponds to the viscosity of 300 dPas is representative of the temperature at which the glass has a viscosity which is suitable for refining. The glasses provided according to the invention can be refined in a viscosity range from 200 to 500 dPas. The viscosity of the glass can be determined with a rotational viscosimeter, e.g. in accordance with DIN ISO 7884-2:1998-2. The dependence of the viscosity on the temperature is determined using the VFT curve (Vogel-Fulcher-Tammann equation).

In some embodiments, the aluminosilicate glass has a refining temperature of at least 1500° C., in particular at least 1550° C. The refining temperature of the aluminosilicate glass can be up to 1700° C. or up to 1650° C.

In some embodiments, the aluminosilicate glass has SiO₂ in an amount of at least 40 wt.-% and/or of at most 75 wt.-%. SiO₂ contributes to the desired viscosity properties and to hydrolytic resistance. The amount of Al₂O₃ can be at least 10 wt.-% and/or at most 30 wt.-%. A certain amount of Al₂O₃ enables the desired chemical temperability. In order to ensure adequate chemical temperability, the aluminosilicate glass may contain at least 9 wt.-% Na₂O. The Na₂O content can be restricted to up to 18 wt.-% or up to 16 wt.-%.

In some embodiments, the glass does not contain any B₂O₃ or only contains a small amount of B₂O₃. B₂O₃ does indeed have a positive influence on hydrolytic resistance. It, however, has a negative effect on chemical temperability. Its content may therefore be restricted to at most 20 wt.-%, at most 10 wt.-%, at most 5 wt.-% or at most 2 wt.-%.

One exemplary aluminosilicate glass which contains alkali metal oxide has the following components:

| | (Wt.-%) |
|---|---|
| SiO₂ | 40-75 |
| Al₂O₃ | 10-30 |
| B₂O₃ | 0-20 |
| Li₂O + Na₂O + K₂O | >0-30 |
| MgO + CaO + SrO + BaO + ZnO | 0-25 |
| TiO₂ + ZrO₂ | 0-15 |
| P₂O₅ | 0-10 |

In some embodiments, the aluminosilicate glass has a beta-OH content expressed as absorption coefficient a of at most 0.32 mm⁻¹. The beta-OH content expressed as absorption coefficient a is a measure of the water content of the glasses. The water content of the aluminosilicate glass is relatively low in comparison with the prior art. Absorption coefficient a is determined by infrared spectroscopy as follows. Firstly, an IR spectrum is recorded and the transmission minimum is determined in the wavelength range from 2.7 to 3.3 μm. The absorption coefficient is determined as following in the case of the wavelength of the minimum.

$$a = \frac{1}{d} \times log \frac{1}{{T}_{i}}$$

in which d is the thickness of the glass, Tᵢ is the pure transmission of the glass in the IR spectrum in the case of the minimum. The pure transmission is Tᵢ=T/P, wherein T is the transmission measured at the minimum and P is the reflection factor, which is assumed to be 0.91 for the glasses provided according to the invention.

In some embodiments, the aluminosilicate glass has less than 0.0001 wt.-% NH₄⁺.

In some embodiments, the aluminosilicate glass has a cooling state which corresponds to a cooling of the glass during production through a temperature range from 50° C. above Tg to 100° C. below Tg with a cooling rate of at least 300° C./min. In particular, the cooling state of the glass corresponds to a cooling rate through this temperature range of at least 1000° C./min. The cooling rate can even be up to 6000° C./min. The aluminosilicate glass can be cooled at such a rate that it has a comparatively high notional temperature, e.g. with the indicated cooling rates around Tg. A high notional temperature is associated with a refractive index which is lower than a refractive index after fine cooling of the same glass composition. A high notional temperature enables comparatively high temperability and a slightly reduced density. The aluminosilicate glass can have a density of less than 2.5 g/cm³. In some embodiments, the glass has a refractive index n_{D} of 1.48 to 1.55. An aluminosilicate glass, which can be produced in particular according to a method provided according to the invention, with a refractive index n_{D} of at most 1.55 and a thickness of less than 500 μm is provided according to the invention. The refractive index of the aluminosilicate glass can be at least 0.0001 smaller than the refractive index after fine cooling. The refractive index of the glass may even be at least 0.0004, for example at least 0.0008 smaller than the refractive index after fine cooling. In some embodiments, the refractive index is even at least 0.001 or 0.002 smaller than the refractive index after fine cooling.

The refractive index after fine cooling is determined in that firstly the refractive index of the aluminosilicate glass is determined, the aluminosilicate glass is, after production, heated again to a temperature which corresponds to T_{G}+20 K and then cooled with a cooling rate of 2 K/h to a temperature of 20° C. Thereafter, the refractive index is measured again (=refractive index after fine cooling) and the difference from the refractive index prior to this renewed cooling is ascertained. In some embodiments, transformation temperature T_{G} of the aluminosilicate glass is around 580 to 650° C.

In some embodiments, the glass article or the aluminosilicate glass can be chemically hardened, in particular with a diffusivity in the range of at least 14 μm²/h, in particular at least 18 μm²/h, or at least 20 μm²/h. The diffusivity can be restricted to at most 60 μm²/h, at most 45 μm²/h or at most 30 μm²/h. Diffusivity D is a measure for the sensitivity of the glass article to chemical tempering. It can be calculated from the depth of the compressive stress layer (DoL, depth of ion exchanged layer) and tempering time t. Here DoL=1.4×\sqrt{4×D×t}.

In this description, the diffusivity is indicated in the case of tempering with KNO₃ at 450° C. over 1 hour. Diffusivity does not mean that the article has to be tempered, but rather describes its sensitivity to this. A glass which cools more rapidly is more sensitive to chemical tempering, it has a higher diffusivity than a glass which cools more slowly.

In some embodiments, the glass article is tempered. The compressive stress on at least one surface of the glass article, in particular on one or both of the largest surfaces of the glass article, is at least 100 MPa, for example at least 200 MPa, at least 300 MPa or at least 400 MPa. In some embodiments, the compressive stress on at least one surface of the glass article, in particular on one or both of the largest surfaces of the glass article, is at most 2000 MPa, at most 1600 MPa, at most 1400 MPa, at most 1000 MPa, at most 800 MPa or at most 750 MPa. The compressive stress can be at least 100 MPa, at least 300 MPa or at least 500 MPa. The desired compressive stresses are introduced in a manner known per se to the person skilled in the art by exchanging smaller ions with larger ions in the surface of the glass. Sodium may be replaced by potassium, in particular using KNO₃. The depth of the compressive stress layer (DoL) can be up to ⅓ of the glass thickness, in particular up to 25%, up to 20% or up to 15% of the glass thickness. DoL can be at least 1% or at least 10% of the glass thickness. The article can be tempered on one side or both sides.

The use of a glass article provided according to the invention in a mobile or portable end device, in particular in a mobile telephone, a tablet computer or a smart watch is also provided according to the invention.

The invention also relates to a method for producing a glass article, in particular a glass article described above, with the steps
providing a mixture for an aluminosilicate glass with an Sn content of less than 500 ppm, in particular for an aluminosilicate glass according to the composition described herein,
melting the mixture to obtain a melt,
refining the melt using the refining action of at least one halogen,
shaping the glass article, in particular in a drawing method.

In some embodiments, the provision of a mixture is performed for an aluminosilicate glass with an Sn content of less than 100 ppm, in particular for an aluminosilicate glass according to the composition described herein.

The drawing method can be selected from a vertical drawing method, such as the down draw method, up draw method, redrawing and overflow fusion method, or a horizontal drawing method, such as the float method.

The halogen with refining action can be used in the form of a halogen compound, in particular a halogenide compound. Suitable halogenide compounds are in particular salts from chlorine anions, bromine anions and/or iodine anions with alkali metal cations or alkaline earth metal cations. Some examples are NaCl, NaBr, NaI, KCl, KBr, KI, MgCl₂, MgI₂, MgBr₂, CaCl₂), CaI₂, CaBr₂ and combinations thereof. Other examples are BaCl₂, BaBr₂, BaI₂, SrCl₂, SrBr₂, SrI₂ and combinations thereof. The quantity used of the halogen can be at least 100 ppm, at least 300 ppm or at least 500 ppm, wherein the indication of quantity relates to the mass ratio of the halogen in the mixture. In some embodiments, the mass amount used of halogen with a refining action in the mixture is at most 10,000 ppm, at most 8,000 ppm, at most 6,000 ppm, at most 5,000 ppm or at most 3,000 ppm. The halogen with refining action serves as a refining agent to remove bubbles during the production of the glass article. The halogen can be added in various forms. In some embodiments, it is added in the form of a halogenide compound, e.g. as salt with an alkali metal or alkaline earth metal cation to the mixture. In some embodiments, the halogen is used as salt and the cation in the salt corresponds to a cation present as an oxide in the aluminosilicate glass. According to the invention, fluorine compounds are not among the halogen compounds which are used for refining since their boiling points are too low and thus a sufficient refining effect cannot be achieved. The mixture can nevertheless contain fluorine or fluorides.

In some embodiments, refining is performed at a temperature at which the melt has a viscosity in the range from 200 to 500 dPas, in particular approximately 300 dPas. The refining temperature (in ° C.) may be in a ratio to the boiling temperature (in ° C.) of the halogen compound used of at least 0.8 and at most 1.4, at least >1 and at most 1.2 or at most 1.15. The melting and/or refining of the glass may be performed at temperatures of at least 1400° C., or at least 1500° C. The temperature may be at most 1700° C., such as at most 1650° C.

In the method, the melt can be at least temporarily in contact with a platinum component, e.g. a platinum tube or a platinum stirrer. The advantages provided according to the invention in terms of only very little wear of the platinum can thus be optimally used. Platinum has great advantages during glass production. It is only mildly corrosive, resistant to high temperatures, while being mechanically stable and conductive, as a result of which it can also be directly heated. The invention enables the advantageous use of platinum even in the case of particularly corrosive glasses.

The shaping of the glass article comprises in particular the drawing of the melt or the glass to form a thin glass article. Here, the glass can be drawn to very small thicknesses, such as approximately <100 μm. If platinum particles are present in the glass, they travel to the surface during the drawing process and impair the quality of the glass.

In some embodiments, the glass is an aluminosilicate glass which has the following components:

| | (Wt.-%) |
|---|---|
| SiO₂ | 40-75 |
| Al₂O₃ | 10-30 |
| B₂O₃ | 0-20 |
| Li₂O + Na₂O + K₂O | >0-30 |
| MgO + CaO + SrO + BaO + ZnO | 0-25 |
| TiO₂ + ZrO₂ | 0-15 |
| P₂O₅ | 0-10. |

In some embodiments, the glass is an aluminosilicate glass which has the following components:

| | (Wt.-%) |
|---|---|
| SiO₂ | 40-75 |
| Al₂O₃ | 10-30 |
| B₂O₃ | 0-20 |
| Li₂O + Na₂O + K₂O | 4-30 |
| MgO + CaO + SrO + BaO + ZnO | 0-15 |
| TiO₂ + ZrO₂ | 0-15 |
| P₂O₅ | 0-10. |

In some embodiments, the glass is an aluminosilicate glass which has the following components:

| | (Wt.-%) |
|---|---|
| SiO₂ | 50-70 |
| Al₂O₃ | 10-27 |
| B₂O₃ | 0-18 |
| Li₂O + Na₂O + K₂O | 5-28 |
| MgO + CaO + SrO + BaO + ZnO | 0-13 |
| TiO₂ + ZrO₂ | 0-13 |
| P₂O₅ | 0-9. |

In some embodiments, the glass is an aluminosilicate glass which has the following components:

| | (Wt.-%) |
|---|---|
| SiO₂ | 55-68 |
| Al₂O₃ | 10-27 |
| B₂O₃ | 0-15 |
| Li₂O + Na₂O + K₂O | 4-27 |
| MgO + CaO + SrO + BaO + ZnO | 0-12 |
| TiO₂ + ZrO₂ | 0-10 |
| P₂O₅ | 0-8. |

Coloring oxides such as Nd₂O₃, Fe₂O₃, CoO, NiO, V₂O₅, MnO₂, TiO₂, CuO, CeO₂, Cr₂O₃ or combinations thereof can, where applicable, be added to the glass. The glass may be free from Sn, Sb and/or As.

In some embodiments, the glass is an aluminosilicate glass which has the following components SiO₂ 50 wt.-%, Al₂O₃12 wt.-%, B₂O₃ 14 wt.-%, BaO 24 wt.-%. In some embodiments, the glass is an aluminosilicate glass which has the following components SiO₂ 61 wt.-%, Al₂O₃ 16 wt.-%, B₂O₃ 8 wt.-%, MgO 3 wt.-%, CaO 8 wt.-%, BaO 4 wt.-%. In some embodiments, the glass is an aluminosilicate glass which has the following components SiO₂ 61 wt.-%, Al₂O₃ 17 wt.-%, B₂O₃ 11 wt.-%, MgO 3 wt.-%, CaO 5 wt.-%, BaO 3 wt.-%.

The glass article can be a thin glass band or a glass film. It can have a thickness of less than 500 μm, less than 350 μm, less than 250 μm, less than 100 μm, or less than 50 μm. In some embodiments, the thickness is at least 3 μm, at least 10 μm, or at least 15 μm. Exemplary thicknesses are 5, 10, 15, 25, 30, 35, 50, 55, 70, 80, 100, 130, 145, 160, 175, 190, 210, 280 or 330 μm.

If the concentration unit ppm is used in this description, in the event of doubt, this refers to mass ratios.

If it is indicated in this description with reference to a chemical element (e.g. Sn, As, Sb) that this component is not contained or the content of this component is restricted to a certain amount, this statement relates to any chemical form. For example, the indication that the glass has an Sn content of less than 100 ppm means that the sum of the mass amounts of the Sn species present (e.g. Sn²⁺ in SnO and Sn⁴⁺ in SnO₂) jointly does not exceed the value of 100 ppm.

If it is stated in this description that the glass is free from a component or does not contain a certain component, it is thus meant that this component may nevertheless be present as a contaminant. This means that it is not added in significant quantities. Insignificant quantities are, according to the invention, quantities of less than 100 ppm, for example less than 50 ppm and less than 10 ppm.

### EXAMPLES

Refining of Aluminosilicate Glasses According to the Prior Art

Corrosion of Noble Metal Components

Aluminosilicate glass with tin oxide contents above 200 ppm was melted and refined. Components composed of noble metal were used here. In this case, a refining tube composed of PtRh10 was used and subsequently examined after 4 months of use. The experiment was performed with Glass 1 of the following table. In a further example, the experiment is performed with Glass 2.

The glass compositions of the glasses are represented in the following table without refining agents:

| Component | Glass 1 (wt. %) | Glass 2 (wt. %) |
|---|---|---|
| SiO₂ | 61 | 62 |
| Al₂O₃ | 17 | 20 |
| B₂O₃ | | 4 |
| Na₂O | 12 | 13 |
| K₂O | 4 | |
| MgO | 4 | 1 |
| ZrO₂ | 2 | |

The noble metal of the tube was corrosively attacked inside the tube, glass-filled pores and deposits of tin oxide were found in the noble metal. The material of the tube exhibited cracks oriented to grain boundaries and rips in the cross-section.

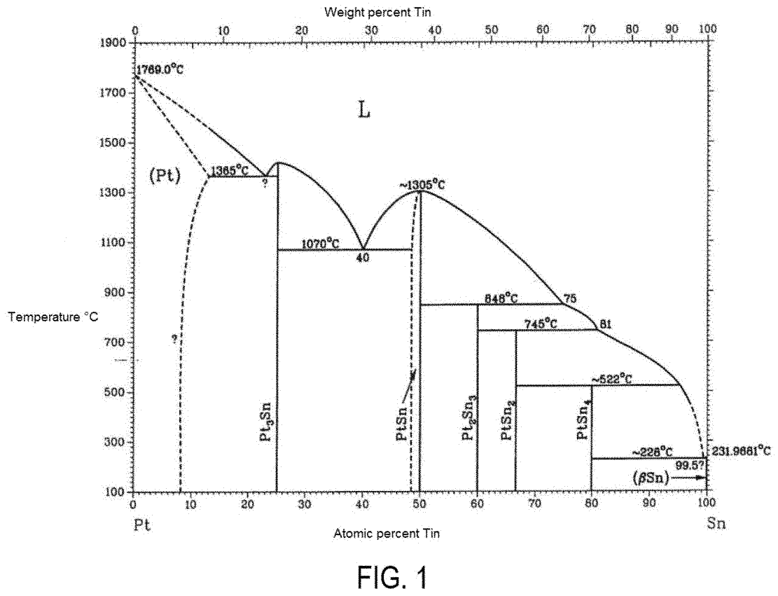

FIG. 1 (Massalski, T B. Binary Alloy Phase Diagrams, Vol. 2, Metals Park, Ohio: American Society for Metals, p. 1910) shows the phase diagram of platinum and tin. Tin forms, with platinum, various eutectic compositions with melting points at 1365° C. and 1070° C. The inventors suspect that the formation of alloy phases of the noble metal with tin is the cause of the damage.

The following table shows the results and observations in detail. Four samples of different sections of the same tube were examined:

| | Sample 1 | Sample 2 | Sample 3 | Sample 4 |
|---|---|---|---|---|
| Outer side | Smooth | | Light- | Open grain |
| | | | coloured | boundaries |
| | | | noble | |
| | | | metal | |
| | | | particles | |
| Material | PtRh8,2 | PtRh8,1 | PtRh8,5 | PtRh7,9 |
| Material | PtRh8,5 | PtRh8,3 | PtRh7,6 | PtRh8,1 |
| Glass | | | | |
| contact | | | | |
| side | | | | |
| Residual | 0.73-0.76 | 0.74-0.82 | | |
| wall | mm | mm | | |
| thickness | | | | |
| Observa- | SnO₂-filled | SnO₂-filled | SnO₂- | Corrosion; |
| tions | cavities; | cavities; | needles in | SnO₂- |
| | detaching | formation | the noble | filled |
| | noble | of noble | metal | cavities on |
| | metal | metal | | glass contact |
| | particle | particles | | side |

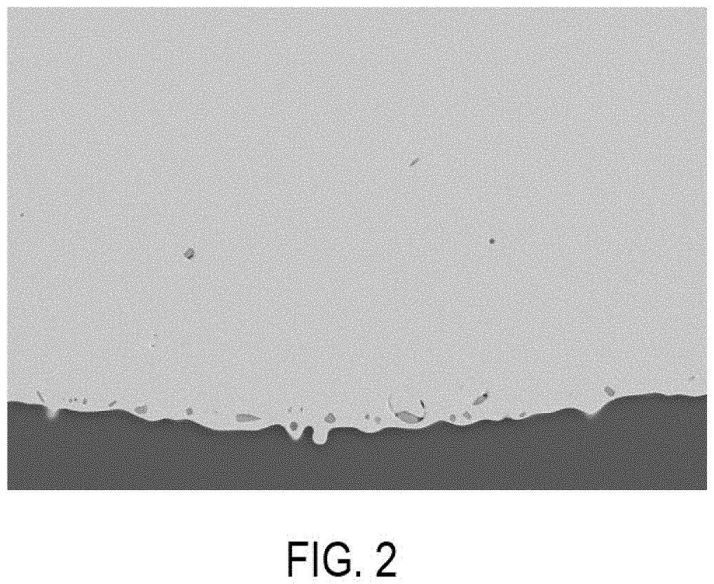

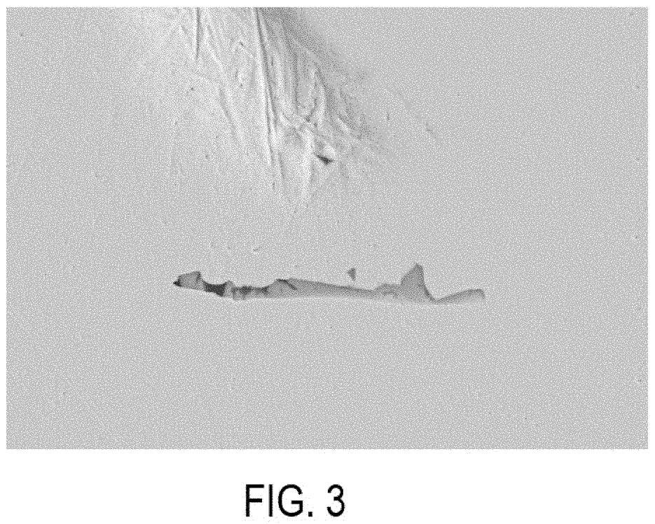

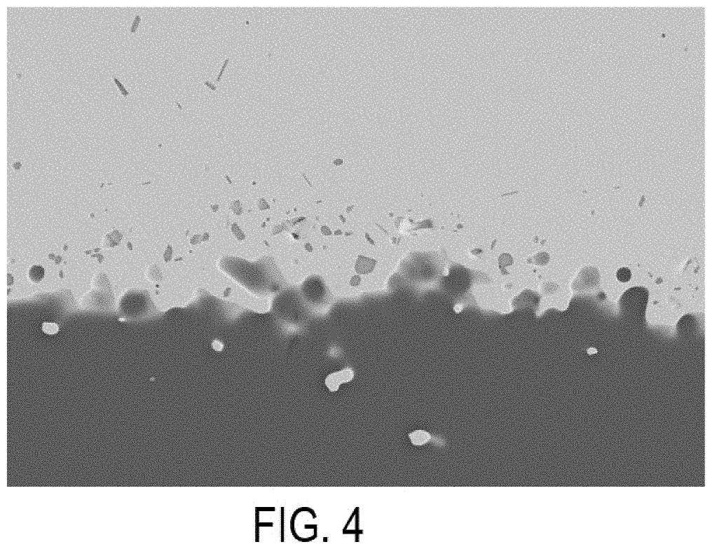

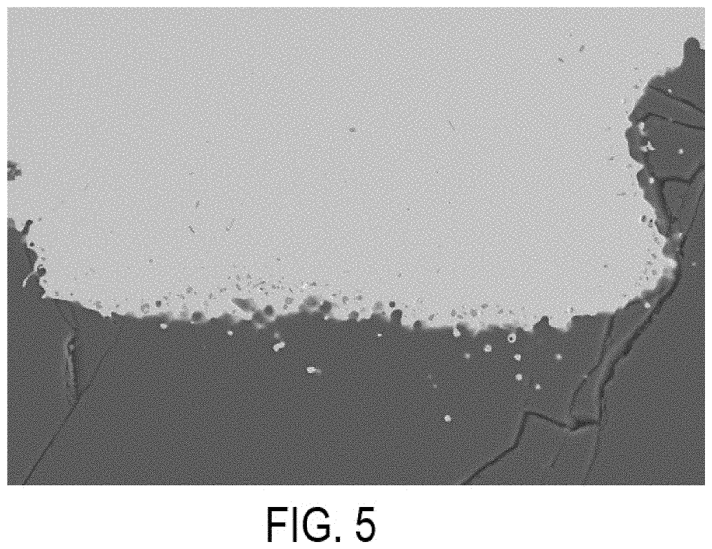

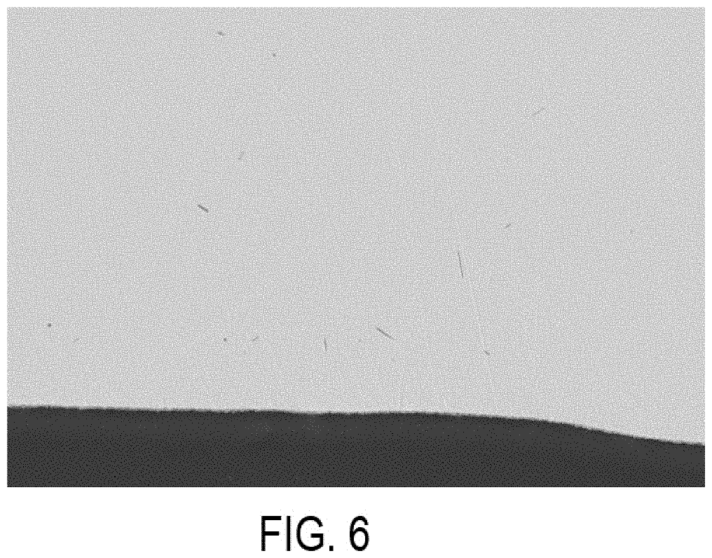

In FIGS. 2 to 6, the light-grey regions show parts of the refining tube. In FIGS. 2 and 4 to 6, the dark regions show the glass which is contact with the refining tube. FIG. 2 shows SnO₂-filled cavities (dark regions in the refining tube) and a detaching noble metal particle in a section of the refining tube which is changed by corrosion. FIG. 3 shows an SnO₂-filled cavity in the noble metal. FIG. 4 shows SnO₂-filled cavities and detached noble metal particles on a section of the refining tube changed by corrosion. FIG. 5 shows detaching and already detached noble metal particles on a section of the refining tube changed by corrosion. FIG. 6 shows SnO₂ needles in a section of the refining tube changed by corrosion. The data show that SnO₂ is involved in the formation of faults in the noble metal tube and significant corrosion occurs with the incorporation of platinum particles into the glass.

Noble Metal Particles in the End Product

As shown above, when using SnO₂ in the glass, significant corrosion occurs and noble metal particles detach from the noble metal component. It was correspondingly possible to detect particles in the end product.

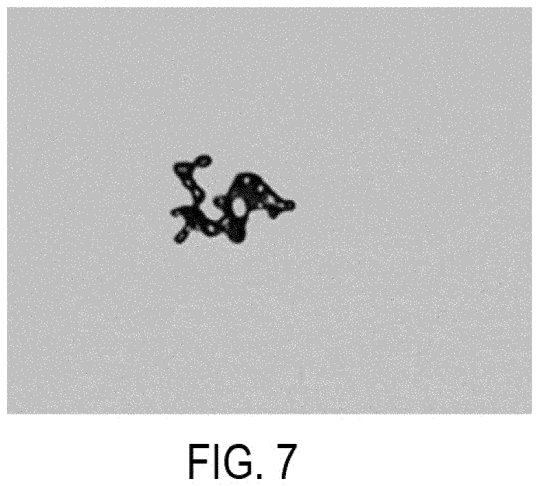

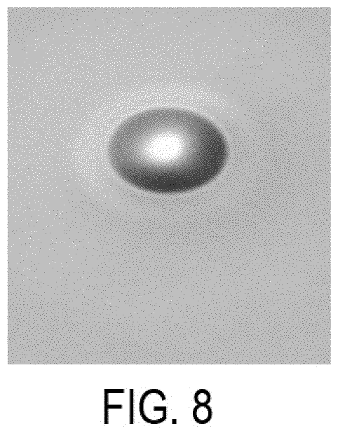

FIGS. 7 and 8 show visual appearances of platinum particles in glass which contains SnO₂. Noble metal particles clearly detach in the melt and precipitate later in the glass. The size of these particles is normally below 60 μm, but they are often significantly smaller, e.g. approx. 5 μm. Such particles are unproblematic in the case of certain applications. However, if such particles occur in particular close to the surface in a thin glass, the particles are particularly obvious since the surfaces swell up in the faulty region and the fault becomes even more visible. Defects thus arise which are significantly larger than the particle itself. Rejection rates of 10-30% arise in manufacture.

Refining of Aluminosilicate Glass

Various melting experiments were performed with the above-mentioned composition of Glass 1 in order to test the refining action. In a further example, the melting experiments are performed with Glass 2. Various quantities of alternative refining agent are compared with the reference SnO₂. The refining agents (RA) are indicated in wt.-% below.

| Rotary | | | | | | | | | |
|---|---|---|---|---|---|---|---|---|---|
| kiln | | | | T1 | t1 | T2 | t2 | Cullet | |
| test | Crucible | RA (%) | | (° C.) | (h) | (° C.) | (h) | (%) | Result |
| 1 | a | 0.25 | SnO2 | 1550 | 3 | 1650 | 1 | 0 | + |
| | b | 0.25 | Cl | | | | | 0 | + |
| | c | 0.5 | Cl | | | | | 0 | ++ |
| 2 | a | 0.25 | SnO2 | 1550 | 3 | 1630 | 1 | 0 | 0 |
| | b | 0.25 | Cl | | | | | 0 | 0 |
| | c | 0.5 | Cl | | | | | 0 | ++ |
| 3 | a | 0.25 | SnO2 | 1500 | 2 | 1600 | 2 | 40 | − |
| | b | 0.5 | Cl | | | | | 0 | ++ |
| | c | 0.5 | Cl | | | | | 40 | ++ |

In the table, “+” designates a good refining result and “++” designates an outstanding refining action. “0” designates an unsatisfactory refining action and “−” designates a very poor refining action. T1 designates the melting temperature, T2 designates the refining temperature. t1 and t2 designate the melting and refining time respectively.

It was surprisingly discovered that the refining result at 1650° C. with chloride was just as good as that with SnO₂, i.e. comparable numbers of residual bubbles were therefore found in the melting crucible. It was furthermore surprising that, in the case of lower refining temperatures (here 1630° C.), the result with chloride was even better than the SnO₂ reference and much better than the SnO₂ variant at even lower refining temperatures (here 1600° C.). A refining agent for aluminosilicate glasses was thus found which delivers better results at lower temperatures than the previous standard refining agent SnO₂. This naturally involves lower energy consumption for the glass melt and lower corrosion of the melt trough material. The results also show that the process window with chloride as the refining agent is significantly larger, the production result is therefore influenced to a lesser extent by fluctuations in the production parameters.

The result is surprising because it was standard expert opinion at the time that the release of refining gasses should be as close as possible to the refining viscosity. The boiling point of NaCl is nevertheless already at 1465° C. and the refining viscosity of the glasses tested here is reached in the temperature range from 1550° C. to 1650° C. NaCl is accordingly actually supposed to release refining gas much too early with a weak refining action. The opposite is the case.

Melting Test in the Production Assembly

A corresponding melting test was then performed in the production assembly with these very positive laboratory results. The overall temperature guidance was initially not changed, rather only refining agent SnO₂ was exchanged for NaCl. The starting quantity of chloride was 0.5% in relation to the weight. This value was also determined in the laboratory melts.

The SnO₂ and Cl contents were determined daily by X-ray fluorescence analysis. After 5 days, the refining agent changeover was completed. No change in bubbling could be identified during this phase and the following days. Bubbles are the key indicator of successful refining of the glass. The changeover of the refining agent was thus completed successfully and further optimisation steps could be taken. The use of cullet, the quantity of refining agent and the refining temperature were varied to define the process window in which the best freedom from faults of the glass can be produced.

The aluminosilicate glass could thus be produced in the production assembly with cullet ratios of 0-50%, a refining agent amount of 0.25-0.70 wt.-% and a refining temperature of 1550 to 1620° C. without the number of bubbles having changed significantly.

After 5 days, the desired reduction in platinum particles arose which fell from 15-20 per kg to 1-3 per kg of glass.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A glass article composed of an aluminosilicate glass with at least one halogen with refining action in an amount ranging from 500 ppm to 8000 ppm and an Sn content of less than 500 ppm, wherein the glass has less than 100 ppm As and less than 100 ppm Sb and wherein the glass article has a thickness of less than 250 μm.

2. The glass article of claim 1, wherein the glass article has no more than 5 platinum particles with diameters of greater than 5 μm per kilogram of glass.

3. The glass article of claim 1, wherein the at least one halogen with refining action is selected from the group consisting of chlorine, bromine, iodine, and combinations thereof.

4. The glass article of claim 1, wherein the aluminosilicate glass has less than at least one of 100 ppm boron or 500 ppm lithium.

5. The glass article of claim 1, wherein the aluminosilicate glass has, in addition to the at least one halogen with refining action, fluorine in an amount ranging from 0.05 to 0.5 wt.-%.

6. The glass article of claim 1, wherein at least one of the following is satisfied:
the aluminosilicate glass contains the at least one halogen with refining action in an amount ranging from 500 to 5000 ppm; or
the Sn content is lower than 100 ppm.

7. The glass article of claim 1, wherein the aluminosilicate glass contains at least one halogen with refining action in an amount of at most 2500 ppm.

8. The glass article of claim 1, wherein the aluminosilicate glass can be chemically hardened with a diffusivity of at most 14 μm²/h.

9. The glass article of claim 1, wherein a ratio between a temperature (T_{L}) in ° C. at which the aluminosilicate glass has its refining viscosity and a temperature in ° C. at a boiling point of NaCl (T_{B(NaCl)}) is at most 1.2.

10. The glass article of claim 1, wherein the aluminosilicate glass has the following components:

| | (Wt.-%) |
|---|---|
| SiO₂ | 40-75 |
| Al₂O₃ | 10-30 |
| B₂O₃ | 0-20 |
| Li₂O + Na₂O + K₂O | >0-30 |
| MgO + CaO + SrO + BaO + ZnO | 0-25 |
| TiO₂ + ZrO₂ | 0-15 |
| P₂O₅ | 0-10. |

11. The glass article of claim 1, wherein the aluminosilicate glass has a beta-OH content of at most 0.32 mm⁻¹.

12. The glass article of claim 1, wherein the aluminosilicate glass has less than 0.0001 wt.-% NH₄⁺.

13. The glass article of claim 1, wherein the aluminosilicate glass has a quotient A in a range from 1.5 to 8.5, wherein the following applies:
$$A = \frac{\frac{{m}_{Al 2 O 3}}{{m}_{RO} + {m}_{R 2 O}}}{{m}_{Cl} + {m}_{I} + {m}_{Br}} ,$$
wherein M_{Al2O3} is a mass amount of Al₂O₃ in the aluminosilicate glass in wt.-%; M_{R2O} is a sum of mass amounts of alkali metal oxides Na₂O, K₂O and Li₂O in wt.-%; m_{R2O} is a sum of mass amounts of alkaline earth metal oxides MgO, CaO, BaO and SrO in weight percent; m_{Cl} is a mass amount of chlorine in wt.-%; m_{I} is a mass amount of iodine in wt.-%; and m_{Br} is a mass amount of bromine in wt.-%.

14. The glass article of claim 1, wherein the aluminosilicate glass has a cooling state which corresponds to a cooling rate of more than 300° C./min in a temperature range from 50° C. above glass transition temperature (Tg) up to 100° C. below Tg.

15. A glass article composed of an aluminosilicate glass, wherein the glass article has no more than 5 platinum particles with diameters of greater than 5 μm per kilogram of glass, wherein the aluminosilicate glass has less than 100 ppm As and less than 100 ppm Sb and wherein the glass article has a thickness of less than 250 μm.

16. The glass article of claim 15, wherein the aluminosilicate glass has the following components:

| | (Wt.-%) |
|---|---|
| SiO₂ | 40-75 |
| Al₂O₃ | 10-30 |
| B₂O₃ | 0-20 |
| Li₂O + Na₂O + K₂O | >0-30 |
| MgO + CaO + SrO + BaO + ZnO | 0-25 |
| TiO₂ + ZrO₂ | 0-15 |
| P₂O₅ | 0-10. |

17. The glass article of claim 15, wherein the aluminosilicate glass has at least one halogen with refining action in an amount ranging from 500 to 8000 ppm and the at least one halogen with refining action is selected from the group consisting of chlorine, bromine, iodine and combinations thereof.

18. A glass article composed of an aluminosilicate glass, wherein the aluminosilicate glass has less than 100 ppm As, less than 100 ppm Sb and less than 500 ppm Sn and wherein a quotient A lies in the range from 1.5 to 8.5, wherein the glass article has a thickness of less than 250 μm and wherein the following applies:
$$A = \frac{\frac{{m}_{Al 2 O 3}}{{m}_{RO} + {m}_{R 2 O}}}{{m}_{Cl} + {m}_{I} + {m}_{Br}} ,$$
wherein M_{Al2O3} is a mass amount of Al₂O₃ in the aluminosilicate glass in wt.-%; M_{R2O} is a sum of mass amounts of alkali metal oxides Na₂O, K₂O and Li₂O in wt.-%; m_{R2O} is a sum of mass amounts of alkaline earth metal oxides MgO, CaO, BaO and SrO in weight percent; m_{Cl} is a mass amount of chlorine in wt.-%; m_{I} is a mass amount of iodine in wt.-%; and m_{Br} is a mass amount of bromine in wt.-%.

19. A glass article composed of an aluminosilicate glass, wherein the aluminosilicate glass has less than 100 ppm As, less than 100 ppm Sb and less than 500 ppm Sn, and a total thickness variation of the glass article is less than 5 μm and wherein the glass article has a thickness of less than 250 μm.

20. The glass article of claim 19, wherein the aluminosilicate glass has the following components:

| | (Wt.-%) |
|---|---|
| SiO₂ | 40-75 |
| Al₂O₃ | 10-30 |
| B₂O₃ | 0-20 |
| Li₂O + Na₂O + K₂O | >0-30 |
| MgO + CaO + SrO + BaO + ZnO | 0-25 |
| TiO₂ + ZrO₂ | 0-15 |
| P₂O₅ | 0-10. |
